(19) United States
(12) Patent Application Publication
(10) Pub. No.: US 2020/0209683 A1
(43) Pub. Date: Jul. 2, 2020

(54) BACKLIGHT UNIT AND LIQUID CRYSTAL DISPLAY DEVICE INCLUDING THE SAME

(71) Applicant: SAMSUNG DISPLAY CO., LTD., YONGIN-SI (KR)

(72) Inventors: KI SE LEE, YONGIN-SI (KR); KYOUNG HO PARK, SEOUL (KR)

(21) Appl. No.: 16/676,984

(22) Filed: Nov. 7, 2019

(30) Foreign Application Priority Data
Jan. 2, 2019 (KR) 10-2019-0000328

(51) Int. Cl. G02F 1/1335; G02F 1/1333

(52) U.S. Cl. CPC G02F 1/133602; G02F 2001/133331; G02F 2202/28; G02F 1/133308

(57) ABSTRACT

A backlight unit includes a first optical member. The first optical member includes a protrusion extending from a surface of the first optical member. A mold frame partially surrounds the surface of the first optical member. The protrusion of the first optical member includes a fixing hole. The mold frame includes at least one fixing protrusion configured to be inserted into the fixing hole of the protrusion.

This application claims priority under 35 U.S.C. § 119 to Korean Patent Application No. 10-2019-0000328, filed on Jan. 2, 2019, in the Korean Intellectual Property Office, the disclosure of which is incorporated by reference herein in its entirety.

### TECHNICAL FIELD

The present invention relates to a backlight unit, and more particularly, to a backlight unit and a liquid crystal display device including the same.

### DESCRIPTION OF THE RELATED ART

A liquid crystal display device may display an image by receiving light from a backlight unit. The backlight unit included in a display device may include a light source and a light guide plate. The light guide plate receives incident light from the light source and guides the light toward a display region of a display panel. In some liquid crystal display devices, white light provided from a light source may be filtered by a color filter of a display panel to express a color.

To increase image quality, such as color reproducibility of a liquid crystal display device, incorporation of a wavelength conversion film has been researched. In this case, a blue light source may be used as a light source, and a wavelength conversion film may be disposed on a light guide plate to convert the light source into white light. The wavelength conversion film may be formed together with an optical film that increases light transmittance and luminance by controlling the optical characteristics of the light having passed through the wavelength conversion film.

However, when a plurality of films are simply laminated, scratches may be generated on the contacting surfaces of the films due to inter-film interference and friction, or the films may be deformed due to high-temperature and high-humidity environments, which may cause a decrease in the reliability of a liquid crystal display device.

### SUMMARY

Exemplary embodiments of the present invention provide for a display device capable of preventing the movement of a backlight unit by coupling a wavelength conversion film and an optical film with a light guide plate and fixing the optical film to an external structure.

An exemplary embodiment of the present invention provides for a backlight unit which includes a first optical member. The first optical member includes a protrusion extending from a surface of the first optical member. A mold frame partially surrounds the surface of the first optical member. The protrusion of the first optical member includes a fixing hole. The mold frame includes at least one fixing protrusion configured to be inserted into the fixing hole of the protrusion.

An exemplary embodiment of the present invention provides for a backlight unit, comprising an optical member that includes a first optical member. A light adjustment member filter is disposed on the first optical member and includes a protrusion region. A first mold frame surrounds the side surface of the first optical member and overlaps the protrusion region of the light adjustment member filter. A second mold frame overlaps the first mold frame and supports the first mold frame and the light adjustment member filter. The light adjustment member filter includes at least one fixing hole formed in the protrusion region. The first mold frame includes at least one fixing protrusion configured to be inserted into the fixing hole of the light adjustment member filter.

An exemplary embodiment of the present invention provides for a display device that includes a display panel and a backlight unit disposed on a surface of the display panel and configured to provide light to the display panel. The backlight unit includes a light source, an optical member including a first optical member including a wavelength conversion layer, and a second optical member disposed on the first optical member and including a protrusion region protruding outward beyond a side surface of the first optical member. A first mold frame surrounds the side surface of the first optical member and overlaps the protrusion region of the second optical member. The second optical member includes at least one fixing hole formed in the protrusion region, and the first mold frame includes at least one fixing protrusion configured to be inserted into the fixing hole of the second optical member.

### BRIEF DESCRIPTION OF THE DRAWINGS

The above and other features of the present invention will become more apparent by describing in detail exemplary embodiments thereof with reference to the attached drawings, in which:

FIG. 1 is an exploded perspective view illustrating a display device according to an exemplary embodiment of the present invention;

FIG. 2 is a perspective view illustrating a cross-section taken along the line II-II ′ of the display device of FIG. 1;

FIG. 3 is a perspective view illustrating the engagement between a fixing hole of an optical member and a fixing protrusion of a mold frame;

FIG. 4 is a cross-sectional view illustrating a second optical member according to an exemplary embodiment of the present invention;

FIGS. 5 and 6 are plan views illustrating a second optical member according to an exemplary embodiment of the present invention;

FIG. 7 is a plan view illustrating a mold frame according to an exemplary embodiment of the present invention;

FIG. 8 is a perspective view illustrating a cross-section taken along the line VIII-VIII′ of FIG. 7;

FIGS. 9A to 9C are enlarged views illustrating an engagement state of a fixing hole and a fixing protrusion according to exemplary embodiments of the present invention;

FIG. 10 is a perspective view illustrating a cross-section taken along the line II-II′ of FIG. 1 according to another exemplary embodiment of the present invention;

FIG. 11 is a perspective view illustrating the engagement between a fixing hole of an optical member and a fixing protrusion of a mold frame according to an exemplary embodiment of the present invention;

FIGS. 12 and 13 are plan views illustrating a second optical member according to exemplary embodiments of the present invention;

FIG. 14 is a cross-sectional view illustrating a second optical member according to according to an exemplary embodiment of the present invention;

FIG. 15 is a plan view illustrating the mold frame of FIG. 10;

FIG. 16 is a perspective view illustrating a cross-section taken along the line XVI-XVI′ of FIG. 15;

FIG. 17 is an exploded perspective view illustrating a display device according to an exemplary embodiment of the present invention;

FIG. 18 is a perspective view illustrating a cross-section taken along the line XVIII-XVIII′ of FIG. 17;

FIG. 19 is a perspective view illustrating the engagement between a fixing hole of an optical member and a fixing protrusion of a mold frame according to an exemplary embodiment of the present invention;

FIGS. 20 and 21 are plan views illustrating a light adjustment filter according to an exemplary embodiment of the present invention.

FIGS. 22A and 22B are plan views illustrating a first mold frame and a second mold frame according to an exemplary embodiment of the present invention.

FIGS. 23A and 23B are perspective views illustrating cross-sections taken along the line XXIII-XXIII′ of FIGS. 22A and 22B;

FIG. 24 is a cross-sectional view illustrating a liquid crystal display device according to an exemplary embodiment of the present invention;

FIG. 25 is a cross-sectional view illustrating a liquid crystal display device according to an exemplary embodiment of the present invention; and

FIG. 26 is a cross-sectional view illustrating a liquid crystal display device according to an exemplary embodiment of the present invention.

### DETAILED DESCRIPTION OF THE EMBODIMENTS

Exemplary embodiments of the present invention will now be described more fully hereinafter with reference to the accompanying drawings. However, the present invention may be embodied in many different forms and should not be construed as limited to the embodiments set forth herein. It will also be understood that when a layer is referred to as being disposed “on” another layer or substrate, it can be disposed directly on the other layer or substrate, or intervening layers may also be present therebetween. It will be understood that like reference numerals may refer to like elements throughout the specification.

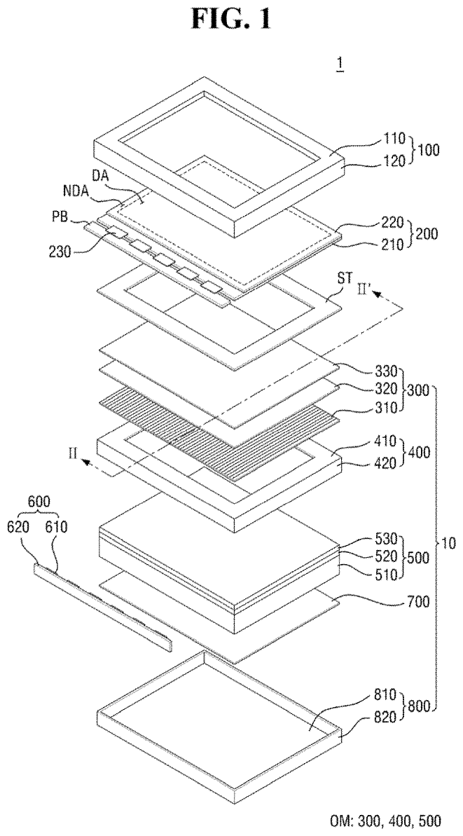

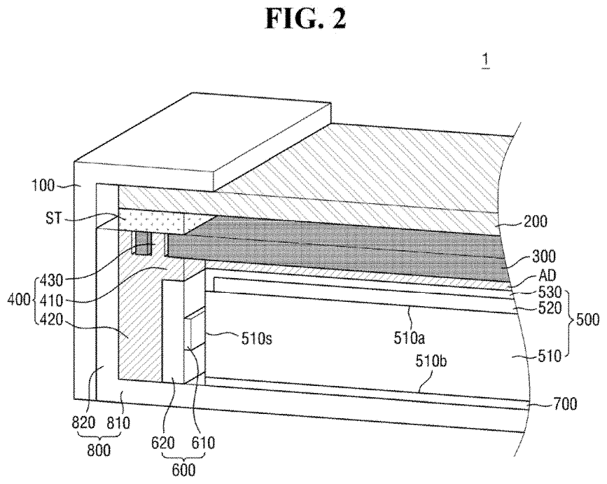

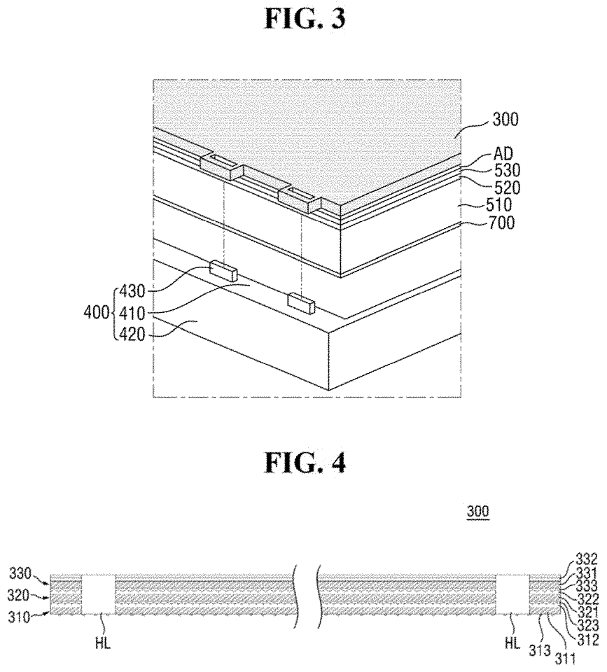

FIG. 1 is an exploded perspective view illustrating a display device according to an exemplary embodiment of the present invention, FIG. 2 is a perspective view illustrating a cross-section taken along the line II-II′ of the display device of FIG. 1, and FIG. 3 is a perspective view illustrating the engagement between a fixing hole of an optical member and a fixing protrusion of a mold frame.

Referring to FIGS. 1 to 3, a display device 1, according to an exemplary embodiment of the present invention, may include a display panel 200, a backlight unit 10, and an upper cover 100.

The display panel 200 may include various light-receiving display panels such as a liquid crystal display panel, an electrowetting display panel, an electrophoretic display panel, and a microelectromechanical system (MEMS) display panel. Hereinafter, a liquid crystal display panel will be described as an example of the display panel 200.

The display panel 200 may receive light generated from the backlight unit 10, and may display an image by adjusting the arrangement of liquid crystals and the refraction of light passing through them.

The display panel 200 may include a thin film transistor substrate 210 (where a thin film transistor is formed), a color filter substrate 220 facing the thin film transistor substrate 210, and a liquid crystal layer interposed between the thin film transistor substrate 210 and the color filter substrate 220.

The liquid crystal display device 1 may further include a driving chip, a driving circuit film 230, and a printed circuit board PB. The driving circuit film 230 may be bent to electrically connect the display panel 200 and the printed circuit board PB. One end of the driving circuit film 230 may be connected to one surface of the thin film transistor substrate 210 exposed by the light passed through the color filter substrate 220, and the other end thereof may be connected to the printed circuit board PB.

The printed circuit board PB may output a signal to the display panel 200 or receive a signal from the display panel 200 through the driving circuit film 230. Although it is shown in FIG. 1 that the printed circuit board PB is disposed on a same plane as the display panel 200, the printed circuit board PB may be disposed at various positions according to the structure of the liquid crystal display device 1. For example, the printed circuit board PB may be disposed on the lower side or lateral side of the backlight unit 10 when the driving circuit film 230 is bent.

The driving chip may receive an external signal, and generate a driving signal for driving the display panel 200. The external signal is a signal supplied from the printed circuit board PB, and may include an image signal, various control signals, and a driving voltage. The driving chip may be mounted on the driving circuit film 230, the printed circuit board PB, or the thin film transistor substrate 210.

The upper cover 100 may include a frame 110 surrounding the edge of the display panel 200 and a side wall 120 extending from the periphery of the frame toward a lower cover 800. In the display panel 200, the area other than a non-display area NDA surrounded by the frame 110 of the upper cover 100 may refer to a display area DA, and the upper cover 100 may further include a window through which light is transmitted outwardly from the display area DA. The side wall 120 of the upper cover 100 may be coupled with the side wall 820 of the lower cover 800 by a coupling means, but the present invention is not limited thereto. The upper cover 100 may be omitted, and, in this case, the display panel 200 may be directly coupled to the cover 800. According to an exemplary embodiment of the present invention, the display panel 200 may be coupled with the side wall 820 of the lower cover 800 by a coupling means (e.g., double-sided tape).

A backlight unit 10 may be disposed behind the display panel 200. The front of the display panel 200 may refer to a front direction in which a screen is displayed, and the back of the display panel 200 may refer to a surface opposite to the front direction. Hereinafter, the front or upper surface of an element may refer to a front direction in which a screen is displayed, and the back of an element may refer to a surface opposite to the front direction. The backlight unit 10 may include a first optical member 500, a second optical member 300, a mold frame 400, a light source module 600, a reflective sheet 700, and a lower cover 800.

The lower cover 800 may have a space capable of accommodating the optical member OM including the first optical member 500 and the second optical member 300, the light source module 600, the reflective sheet 700, and the mold frame 400. Specifically, the lower cover 800 may include a bottom plate 810 and a side wall 820 protruding and extending upwardly along the periphery of the bottom plate 810. For example, the perimeter of the side wall 820 may be elevated relative to an upper surface the bottom plate 810.

The light source module 600 may be disposed to face one side surface of the first optical member 500. For example, the light source module 600 may be disposed adjacent to the light incidence surface 510s of a light guide plate 510 of the first optical member 500. The light source module 600 may include a plurality of point light sources or linear light sources. The point light source may be a light emitting diode (LED) light source 610. The plurality of LED light sources 610 may be mounted on a printed circuit board 620. The LED light source 610 may emit blue light.

According to an exemplary embodiment of the present invention, the LED light source 610 may be a side emission-type LED that emits light laterally. In this case, the printed circuit board of the light source module 620 may be disposed on the bottom plate 810 of the lower cover 800.

According to an exemplary embodiment of the present invention, the LED light source 610 may be a top emission-type LED that emits light upward. In this case, the printed circuit board of the light source module 620 may be disposed on the side wall 420 of the mold frame 400. A height from an upper surface of the upper surface 410 of the mold frame 400 to an upper end of the fixing protrusion 430 may be equal to a thickness of the second optical member 300.

The blue light emitted from the LED light source 610 may be incident on the light guide plate 510 of the first optical member 500. The light guide plate 510 of the first optical member 500 may guide light and emit the light through the upper surface 510a or lower surface 510b of the light guide plate 510. The wavelength conversion layer 520 of the first optical member 500 may convert a part of the blue light from the light guide plate 510 into another wavelength of light, such as a wavelength corresponding to green light and red light. The green light and red light converted by the wavelength conversion layer 520 may be emitted upward together with the blue light not converted by the wavelength conversion layer 520 and transmitted toward the display panel 200.

The reflective sheet 700 may be disposed in the lower cover 800. However, the present invention is not limited thereto. For example, the reflective sheet 700 may be disposed along a front surface of the bottom plate 810 of the lower cover 800 and/or the inner side surface of the side wall 820 of the lower cover 800.

The reflective sheet 700 may be disposed beneath the light guide plate 510 and may guide light incident on the lower surface 510b of the light guide plate 510 back an upper surface 510a of the light guide plate 510. The reflective sheet 700 disposed behind the lower surface 510b of the light guide plate 510 may be made of, for example, a plastic material and/or a metal having a high reflectance.

The optical member OM integrally includes the first optical member 500 for converting the wavelength of incident light and the second optical member 300 for increasing the light transmittance and luminance by adjusting the optical characteristics of the incident light. According to an exemplary embodiment of the present invention, the second optical member 300 and the first optical member 500 may be attached to each other by an adhesive layer AD.

The first optical member 500 may include a light guide plate 510, a wavelength conversion layer 520 disposed on the light guide plate 510, and a passivation layer 530 disposed on the wavelength conversion layer 520.

The light guide plate 510 may serve to guide the traveling path of light. The light guide plate 510 may have a substantially polygonal columnar shape. The planar shape of the light guide plate 510 may be rectangular, but is not limited thereto. According to an exemplary embodiment of the present invention, the light guide plate 510 may have a hexagonal columnar shape with a rectangular planar shape, and the hexagonal columnar shape may include an upper surface 510a, a lower surface 510b, and four side surfaces 510s.

According to an exemplary embodiment of the present invention, the upper surface 510a and lower surface 510b of the light guide plate 510 are located on parallel planes. The plane on which the upper surface 510a is located and the plane on which the lower surface 510b is located may be substantially parallel to each other, and thus the light guide plate 510 may have a uniform thickness. However, the present invention is not limited thereto, and the upper surface 510a or the lower surface 510b may be formed to include a plurality of planes, or the plane on which the upper surface 510a is located and the plane on which the lower surface 510b is located may intersect each other. For example, a wedge shaped light guide plate 510 may have a non-uniform thickness that may be thinner from one side surface (for example, the light incidence surface) to the other side surface (for example, light facing surface) facing the one side surface. Further, adjacent to the light incidence surface the lower surface 510b may be inclined upward toward the other side surface facing the one side surface to reduce the thickness thereof. The upper surface 510a and the lower surface 510b may each be formed in a planar shape.

The upper surface 510a and/or the lower surface 510b may orthogonally connect to respective side surfaces 510s. According to an exemplary embodiment of the present invention, the light guide plate 510 may further include an inclined surface disposed between the upper surface 510a and one side surface 510s or between the lower surface 510b and one side surface 510s. Hereinafter, a case where the upper surface 510a and the lower surface 510b, disposed in parallel planes, orthogonally connect to respective side surface 510s will be described.

A scattering pattern may be disposed on the lower surface 510b of the light guide plate 510. The scattering pattern serves to reflect at least some incident light traveling in the light guide plate 510 using total reflection, and thereby emit the light to the outside of the light guide plate 510.

According to an exemplary embodiment of the present invention, the scattering pattern may be provided as a separate layer or pattern. For example, a pattern layer including a protruding pattern and/or a concave groove pattern may be formed on the lower surface 510b of the light guide plate 510, or a print pattern may be formed thereon, so as to allow the pattern layer or the print pattern to function as the scattering pattern.

According to an exemplary embodiment of the present invention, the scattering pattern may be formed to have a surface shape of the light guide plate 510. For example, a concave groove may be formed on the lower surface 510b of the light guide plate 510 to allow the concave groove to function as the scattering pattern.

The arrangement density of the scattering pattern may differ among regions. For example, the arrangement density of the scattering pattern may be low in a region adjacent to the light incidence surface, which is relatively high in light exposure, but the arrangement density may be high in a region adjacent to the light facing surface, which is relatively poor in light amount.

The light guide plate 510 may include a material such as glass, quartz, and/or polymer, having high transparency such that light can be efficiently guided. Examples of the polymer may include an acrylic resin such as poly(methyl methacrylate) (PMMA) and a material having a predetermined refractive index such as polycarbonate (PC).

The wavelength conversion layer 520 may be disposed on the upper surface of the light guide plate 510. The wavelength conversion layer 520 may convert the wavelength of at least some of the incident light. The wavelength conversion layer 520 may include a binder layer and wavelength conversion particles dispersed in the binder layer. The wavelength conversion layer 520 may further include scattering particles dispersed in the binder layer in addition to the wavelength conversion particles.

The binder layer may be a medium in which the wavelength converting particles are dispersed, and may be made of various resin compositions which may be generally referred to as a binder. However, the present invention is not limited thereto. As used herein, a medium capable of dispersing and arranging the wavelength converting particles and/or scattering particles may be referred to as a binder layer regardless of its name, additional functions, constituent materials, and the like.

The wavelength conversion particles may be particles for converting the wavelength of incident light, and may include, for example, quantum dots (QD), fluorescent material particles, and/or phosphorescent material particles. When quantum dots are utilized, the quantum dots may include a material having a crystal structure of several nanometers between adjacent constituent units, and may be composed of several hundreds to several thousands of atoms or compounds, and may exhibit a quantum confinement effect of increasing an energy bandgap due to a small size. When light having a wavelength higher than the energy bandgap of the quantum dot is applied to the quantum dot, the quantum dot absorbs the light to enter an excited state, and emits light having a specific wavelength upon falling to a ground state. The wavelength of the emitted light may have a value corresponding to the difference between the energy bandgap and the energy of the ground state. The quantum dots can control the luminescence characteristics due to the quantum confinement effect by adjusting the size and composition thereof.

The quantum dot may include at least one of a Group II-VI compound, a Group II-V compound, a Group III-VI compound, a Group III-V compound, a Group IV-VI compound, a Group compound, a Group II-IV-VI compound, and a Group II-IV-V compound.

The quantum dot may include a core and a shell overcoating the core. For example, the core may include, but is not limited to, at least one of CdS, CdSe, CdTe, ZnS, ZnSe, ZnTe, GaN, GaP, GaAs, GaSb, AlN, AlP, AlAs, AlSb, InP, InAs, InSb, SiC, Ca, Se, In, P, Fe, Pt, Ni, Co, Al, Ag, Au, Cu, FePt, Fe2O3, Fe3O4, Si, and/or Ge. The shell may include, but is not limited to, at least one of ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TlN, TlP, TlAs, TlSb, PbS, PbSe, and/or PbTe.

The wavelength conversion particles may include a plurality of wavelength conversion particles that convert incident light into light of different wavelengths. For example, the wavelength conversion particles may include first wavelength conversion particles that convert incident light of a specific wavelength into light of a first wavelength before transmission, and second wavelength conversion particles that convert incident light of a specific wavelength into light of a second wavelength before transmission. According to an exemplary embodiment of the present invention, the light emitted from the light source 610 and incident on the wavelength conversion particles may be light of a blue wavelength. The first wavelength (e.g., the incident light that has been converted by first wavelength conversion particles) may be a green wavelength, and the second wavelength (e.g., the incident light that has been converted by second wavelength conversion particles) may be a red wavelength. For example, the blue wavelength is a wavelength having a peak at 420 nm to 470 nm, the green wavelength is a wavelength having a peak at 520 nm to 570 nm, and the red wavelength may be a wavelength having a peak at 620 nm to 670 nm. However, it should be understood that the blue, green, and red wavelengths are not limited to the above example ranges and may include all wavelength ranges that can be recognized as blue, green, and red.

According to an exemplary embodiment of the present invention, while the blue light incident on the wavelength conversion layer 520 may pass through the wavelength conversion layer 520, a portion of the blue incident light may enter the first wavelength conversion particles to be converted into light of a green wavelength and emitted, another portion of the blue incident light may enter the second wavelength conversion particles to be converted into a light of a red wavelength and emitted, and a residual part of the blue light may be directly emitted without entering the first wavelength conversion particles and the second wavelength conversion particles. When the ratio of the emitted light of different wavelengths is appropriately adjusted, white light or light of another color may be displayed. The light converted through the wavelength conversion layer 520 may be concentrated within a narrow range of specific wavelengths, and may have a sharp spectrum with a narrow half width. Therefore, when colors are expressed by filtering the light of such a spectrum with a color filter, color reproducibility can be improved.

Incident light may be a short-wavelength light such as ultraviolet light, and three kinds of wavelength conversion particles for converting the incident light into light of blue, green and red wavelengths may be arranged in the wavelength conversion layer 520 to emit composite white light.

The wavelength conversion layer 520 may further include scattering particles. The scattering particles may be non-quantum particles, and may also be particles having no wavelength conversion function. The scattering particles may scatter incident light such that more incident light can be incident onto the wavelength conversion particles. In addition, the scattering particles may serve to uniformly control the emission angle of light for each wavelength. In other words, when a portion of incident light is incident on the wavelength conversion particles to convert a wavelength before emission, the converted light is scattered randomly. If the scattering particles are not included in the wavelength conversion layer 520, the light of green and red wavelengths emitted after the collision with the wavelength conversion particles may be scattered, but the light of a blue wavelength emitted without the collision with the wavelength conversion particles is not scattered, so that the amount of emission of light of blue/green/red wavelengths may be different from one another. The scattering particles may scatter the blue wavelength light that is emitted without the collision with the wavelength conversion particles, so as to adjust the emission angle of light. The scattering particles may include TiO₂ and/or SiO₂.

A passivation layer 530 may be disposed on the wavelength conversion layer 520. The passivation layer 530 may serve to prevent the permeation of impurities such as moisture or oxygen. The passivation layer 530 may include an inorganic material. For example, the passivation layer 530 may include silicon nitride, aluminum nitride, zirconium nitride, titanium nitride, hafnium nitride, tantalum nitride, silicon oxide, aluminum oxide, titanium oxide, tin oxide, cerium oxide, and/or silicon oxynitride, and/or may include a metal thin film having high light transmittance. According to an exemplary embodiment of the present invention, the passivation layer 530 may be made of, for example, silicon nitride.

The passivation layer 530 may completely overlap the wavelength conversion layer 520, cover the upper surface of the wavelength conversion layer 520, and extend further outwardly therefrom to cover the side surface of the wavelength conversion layer 520. The passivation layer 530 may be in contact with the upper surface and side surface of the wavelength conversion layer 520. The passivation layer 530 may extend to the upper surface of the edge of the light guide plate 510 exposed by the wavelength conversion layer 520 to allow a part of the edge of the passivation layer 530 to be in direct contact with the upper surface of the light guide plate 510. According to an exemplary embodiment of the present invention, the side surface of the passivation layer 530 may be aligned with the side surface of the light guide plate 510.

Meanwhile, the wavelength conversion layer 520 may be sealed with the passivation layer 530 or the like, thereby preventing the deterioration of the wavelength conversion layer 520. Further, the wavelength conversion layer 520 of the first optical member 500 and its sealing structure may reduce a manufacturing cost and the thickness of a wavelength conversion film provided as a separate film.

The second optical member 300 may be disposed between the first optical member 500 and the display panel 200.

The adhesive layer AD may be interposed between the second optical member 300 and the first optical member 500 to attach the second optical member 300 and the first optical member 500 to each other. The adhesive layer AD may be a film having adhesion properties at both upper and lower surfaces, and may be made of, for example, pressure-sensitive adhesive (PSA), optical clear adhesive (OCA), and/or optical clear resin (OCR). The adhesive layer AD may include acrylic resin and/or silicone resin. The adhesive layer AD, according to an exemplary embodiment of the present invention, may have an elongation rate of 100% to 1,000% and a refractive index of 1.0 to 1.6.

The lower surface of the adhesive layer AD may be in contact with the upper surface of the passivation layer 530, and the upper surface of the adhesive layer AD may be in contact with the lower surface of the second optical member 300. The area of the adhesive layer AD may be equal to the area of the display area of the display panel 200. However, the present invention is not limited thereto, and the area of the adhesive layer AD may be larger than the area of the display area. For example, the area of the adhesive layer AD may be substantially the same as the area of the first optical member 500.

When the second optical member 300 is attached to the first optical member 500 by the adhesive layer AD, the occurrence of scratches due to mutual friction can be prevented, and when the second optical member 300 is attached to the rigid surface of the first optical member 500, sheet stick can be prevented, so that the reliability of the liquid crystal display device can be improved. The optical member OM comprising the first optical member 500 and the second optical member 300 may perform a light guide function, a wavelength conversion function, and an optical property control function at the same time as a single integrated member. The integrated single member can simplify the assembly process of the display device thereby reducing manufacturing time and cost.

According to an exemplary embodiment of the present invention, the second optical member 300 may comprise a composite film in which two or more optical functional layers are integrated.

FIG. 4 is a cross-sectional view of a second optical member 300 according to an exemplary embodiment of the present invention.

Referring to FIG. 4, the second optical member 300 may include a first film 310, a second film 320, and a third film 330, which may be integrally formed.

The first film 310 may include a first substrate 311, a back coating layer 313 disposed on a lower surface of the first substrate 311, and a first optical pattern layer 312 disposed on an upper surface of the first substrate 311. When the second optical member 300 is disposed apart from the first optical member 500, the back coating layer 313 may be omitted.

The second film 320 may include a second substrate 321, a first bonding resin layer 323 disposed on a lower surface of the second substrate 321, and a second optical pattern layer 322 disposed on an upper surface of the second substrate 321.

The third film 330 may include a third substrate 331, a second bonding resin layer 333 disposed on a lower surface of the third substrate 331, and an optical layer 332 disposed on an upper surface of the third substrate 331.

The first optical pattern layer 312 may include a convex portion and/or a concave portion, and a part of the convex portion may be in contact with or partially penetrate into the first bonding resin layer 323. An air layer may be disposed between the concave portion of the first optical pattern layer 312 and the first bonding resin layer 323.

The second optical pattern layer 322 may include a convex portion and a concave portion, and a part of the convex portion may be in contact with or partially penetrate into the second bonding resin layer 333. An air layer may be disposed between the concave portion of the second optical pattern layer 322 and the second bonding resin layer 333.

According to an exemplary embodiment of the present invention, the first optical pattern layer 312 may be a microlens pattern layer or a diffusion layer, the second optical pattern layer 322 may be a prism pattern layer, and the optical layer 332 of the third film 330 may be a reflective polarizing layer. According to another exemplary embodiment of the present invention, the first optical pattern layer 312 may be a prism pattern layer (which extends in a direction crossing the prism pattern of the first optical pattern layer), the second optical pattern layer 322 may be a prism pattern layer, and the optical layer 332 of the third film 330 may be a reflective polarizing layer. In the above described exemplary embodiments of the present invention, the third substrate 331 of the third film 330 may be omitted, and the second bonding resin layer 333 may be disposed on the lower surface of the optical layer 332. Various different optical function layers may be used other than the first optical pattern layer 312, the second optical pattern layer 322 and the optical layer 332. Further, two films or four or more films may be integrated and applied.

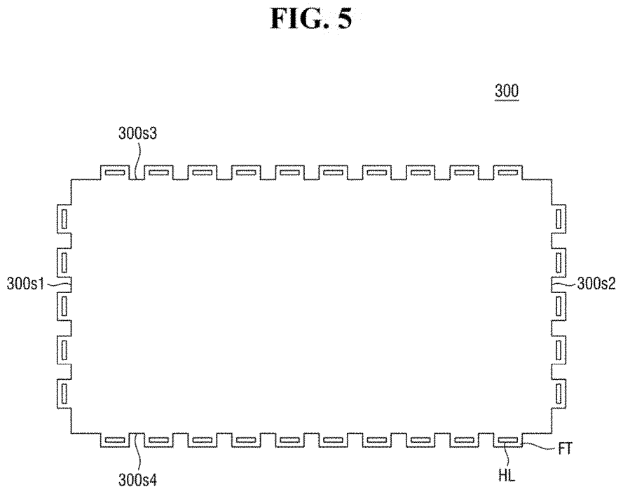

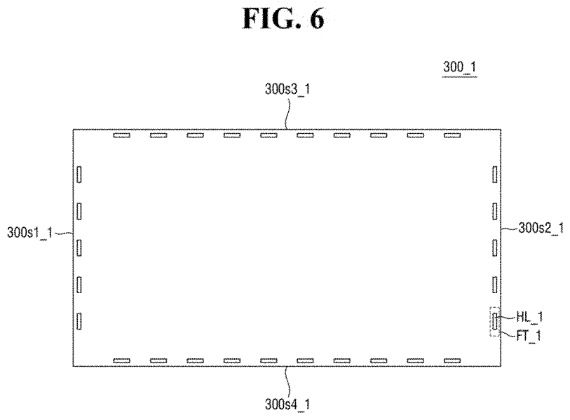

As such, at least one side surface of the second optical member 300 formed by integrating a plurality of films may include at least one fixing hole HL. A more detailed description thereof will be made with reference to FIGS. 5 and 6.

FIGS. 5 and 6 are plan views of a second optical member according to an exemplary embodiment of the present invention.

At least one of side surfaces 300s1, 300s2, 300s3, and 300s4 of the second optical member 300 may be provided with fixing portions FT, and each of the fixing portions FT may be provided with a fixing hole H L. The second optical member 300 may be laminated on the upper surface 410 of the mold frame 400, and the fixing protrusions 430 of the mold frame 400 are inserted into the fixing holes HL of the fixing portion FT of the second optical member 300. That is, the fixing protrusions 430 of the mold frame 400 may penetrate through the fixing holes HL of the second optical member 300, and thus the mold frame 400 and the second optical member 300 coupled to each other.

Referring to FIG. 5, the fixing portion FT according to an exemplary embodiment of the present invention may be formed to protrude from at least one of side surfaces 300s1, 300s2, 300s3, and 300s4 of the second optical member 300. The second optical member 300 may be a rectangular plate having two long sides 300s3 and 300s4 and two short sides 300s1 and 300s2. The second optical member 300 may include five fixing portions FT protruding from each of the upper and lower long sides 300s3 and 300s4 and five fixing portions FT protruding from each of the left and right short sides 300s 1 and 300s2. Each of the fixing holes HL formed in the plurality of fixing portions FT may have a rectangular shape.

Referring to FIG. 6, the second optical member 300_1 according to another exemplary embodiment of the present invention may include fixing portions FT_1 formed inside of an edge the second optical member 300_1 rather than disposed as individual protrusions extending from an edge. The second optical member 300_1 may be a rectangular plate having two long sides 300s3_1 and 300s4_1 and two short sides 300s1_1 and 300s2_1. The second optical member 300_1 may include five fixing portions FT_1 spaced apart from the edge of each of the upper and lower long sides 300s3_1 and 300s4_1 toward the inside of the second optical member 300_1 by a predetermined distance, and feature five fixing portions FT_1 spaced apart from the edge of each of the left and right short sides 300s1_1 and 300s2_1 toward the inside of the second optical member 300_1 by a predetermined distance. According to an exemplary embodiment of the present invention, corners of orthogonally connected short sides 300s1_1 and 300s2_1 and long sides 300s3_1 and 300s4 1 of the second optical member 300 1 may be free of fixing portions FT_I.

However, the number of the fixing portions FT _1 of the second optical member 300_1 and the shape of the fixing hole HL_1 formed in each of the fixing portions FT _1 are not limited to that which is illustrated. For example, the number of the fixing portions FT _1 may be increased or decreased in proportion to the area of the display device, and the fixing hole HL _1 formed in each of the fixing portions FT_1 may be various shapes such as a circle, an ellipse, and a polygon, if the shape of the fixing hole HL_1 matches the shape of the fixing protrusion 430 of the mold frame 400.

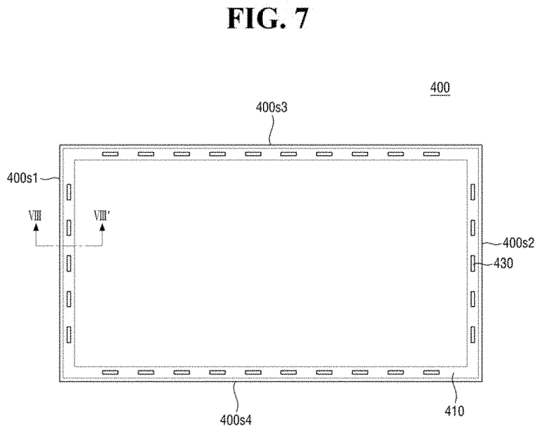

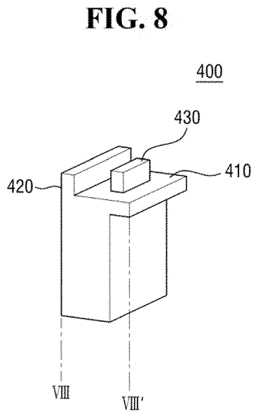

Referring to FIGS. 1 to 3 again, the mold frame 400 may be disposed between the lower cover 800 and the upper cover 100 and may support/fix the first optical member 500 and the second optical member 300. A detailed description thereof will be made with reference to FIGS. 7 and 8.

FIG. 7 is a plan view illustrating a mold frame according to an exemplary embodiment of the present invention, and FIG. 8 is a perspective view illustrating a cross-section taken along the line VIII-VIII′ of FIG. 7.

Referring to FIG. 7, the mold frame 400 may have a rectangular shape including two long sides 400s3 and 400s4 and two short sides 400s1 and 400s2 when viewed in a plan view. The upper surface 410 of the mold frame 400 may include a rim disposed adjacent to the edge of the first optical member 500, and a region other than the rim may be referred to as an “opened region”. The rim of the mold frame 400 may include ten fixing protrusions 430 at each of the upper and lower long sides 400s3 and 400s4, and may include five fixing protrusions 430 at each of the left and right short sides 400s1 and 400s2. Each of the plurality of fixing protrusions 430 may extend in a perpendicular direction relative to a planar surface of the mold frame 400. Each of the plurality of protrusions 430 viewed in a plan view may have a rectangular shape corresponding to the shape of the aforementioned fixing hole HL. The opened region may be a region overlapping the display area (active area) of the aforementioned display panel 200.

Referring to FIG. 8, the mold frame 400 may include: a side wall 420 that contacts the side wall 820 of the lower cover 800, an upper surface 410 bent and extended from the side wall 420, and a fixing protrusion 430 protruding from the upper surface 410 and fixing the second optical member 300. The fixing protrusion 430 may have a rectangular parallelepiped shape whose plane shape is rectangular. The fixing protrusion 430 may penetrate through the fixing hole HL formed in the fixing portion FT of the second optical member 300 and may be engaged with the second optical member 300 to prevent the leftward and rightward movement of the first optical member 500 and the second optical member 300.

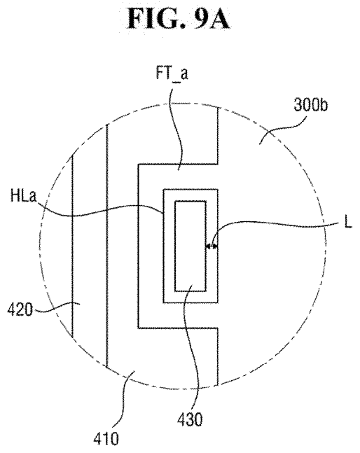

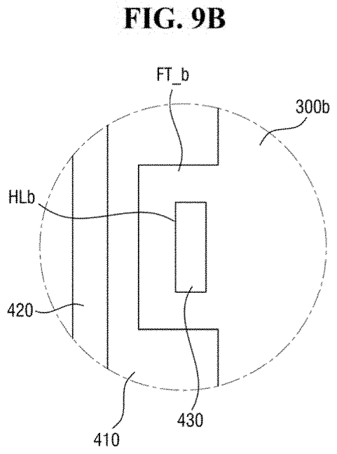

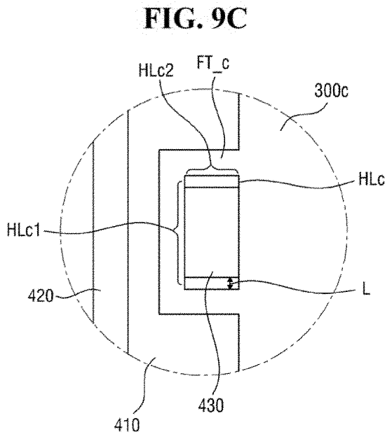

FIGS. 9A to 9C are enlarged views of an engagement state of a fixing hole and a fixing protrusion.

Referring to FIG. 9A, when viewed in a plan view, the shapes of the fixing hole HLa formed in the fixing portion FT_a of the second optical member 300_a and the fixing protrusion 430 of the mold frame 400 engaged with the fixing hole HLa may all be substantially rectangular. In this case, the fixing hole HLa formed in the fixing portion FT_a of the second optical member 300b may be spaced apart from the fixing protrusion 430 inserted therein by a predetermined distance L along the outline of the fixing protrusion 430 of the mold frame 400. According to an exemplary embodiment of the present invention, the second optical member 300b may be formed as a single film. When the second optical member 300b may be formed as a single film, the tensile strength of the second optical member 300b may be weak as compared to when the second optical member 300b may be formed as a multi-layer film in which a plurality of films are integrated with each other. A predetermined distance L is provided between the fixing hole HLa and the fixing protrusion 430, and thus movement of the optical member OM may be allowed to some extent, thereby supplementing insufficient tensile strength.

Referring to FIG. 9B, when viewed in a plan view, the planar shapes of the fixing hole HLb formed in the fixing portion FT_b of the second optical member 300b and the fixing protrusion 430 of the mold frame 400 engaged with the fixing hole HL_b may all be rectangular. The fixing hole HLb formed in the fixing portion FT_b of the second optical member 300b may have a shape that corresponds to the shape of the fixing protrusion 430 of the mold frame 400. For example, when viewed in a plan view, the fixing hole HLb may not be provided with a predetermined distance L from a side of the fixing protrusion 430, unlike the exemplary embodiment of the present invention illustrated in FIG. 9A. According to an exemplary embodiment of the present invention, the second optical member 300b may be formed including a plurality of films, and may have increased tensile strength when the plurality of films are integrally formed. When the fixing hole HLb is completely aligned with the fixing protrusion 430, the movement of the optical member OM may be effectively prevented, and thus the reliability of the liquid crystal display device 1 may be increased.

Referring to FIG. 9C, when viewed in a plan view, the planar shapes of the fixing hole HLc formed in the fixing portion FT_c of the second optical member 300c and the fixing protrusion 430 of the mold frame 400 engaged with the fixing hole HL_c may all be rectangular. In this case, the fixing hole HLc formed in the fixing portion FT_c of the second optical member 300c may be spaced apart from a part of the side surface of the fixing protrusion 430 by a predetermined distance L′. For example, the two long sides HLc1 of the fixing hole HLc may be in contact with the fixing protrusion 430, and the two short sides HLc2 may be spaced apart from the fixing protrusion 430 by a predetermined distance L′. The predetermined distance L′ allows some limited movement of the optical member OM. Thus tensile strength may be supplemented.

When the fixing portion FT of the second optical member 300 is engaged with the fixing protrusion 430 of the mold frame 400, it is possible to prevent a problem of missalignment that may occur in assembling a backlight unit and may also prevent problems such as light leakage and dark area occurrence. Additionally, it is possible to prevent damage from occurring to the first optical member 500 during testing or transportation as well as increase the reliability of the liquid crystal display device 1.

Referring back to FIGS. 1 to 3, a spacer tape ST may be disposed between the display panel 200 and the second optical member 300 and between the display panel 200 and the mold frame 400.

The spacer tape ST, which is a spacer member having a predetermined thickness to support the display panel 200 supported by the second optical member 300 and the mold frame 400, may include a buffer member, a first adhesive layer disposed on one side of the buffer member to attach the buffer member to the display panel 200, and a second adhesive layer disposed on the other side of the buffer member to attach the buffer member to the mold frame 400.

The spacer tape ST may have a rectangular shape when viewed in a plan view. The spacer tape ST may include a rim at least partially overlapping the non-display area NDA of the display panel 200, and a region other than the rim may be opened. The opened region may be a region overlapping the display area DA of the aforementioned display panel 200. The width of the rim of the spacer tape ST may match the width of the upper surface 410 of the mold frame 400. According to an exemplary embodiment of the present invention, the spacer tape ST may cover the fixing hole HL of the second optical member 300. However, the present invention is not limited thereto, and the width of the rim of the spacer tape ST may be variously changed as long as it does not overlap the display area DA of the display panel 200.

Hereinafter, other exemplary embodiments of the present invention will be described. In the following embodiments, a description of the same configuration as that of the aforementioned embodiment will be omitted or simplified, and differences will be mainly described.

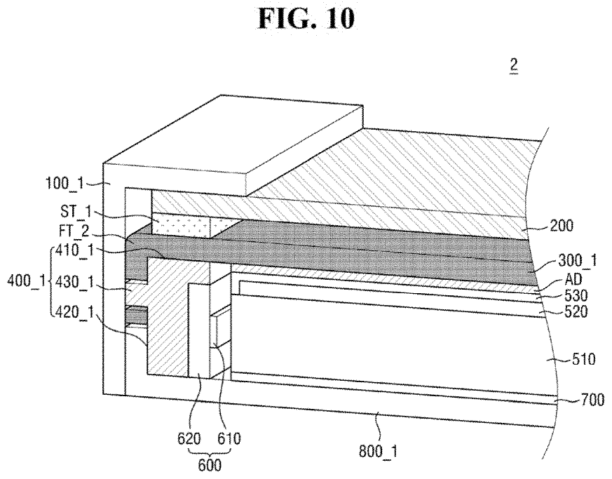

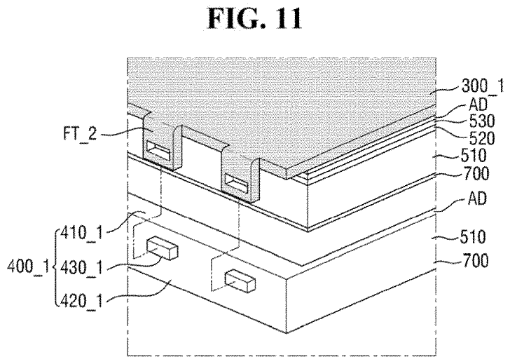

FIG. 10 is a perspective view illustrating a cross-section taken along the line II-II′ of FIG. 1 according to an exemplary embodiment of the present invention, and FIG. 11 is a perspective view illustrating a state of engagement between a fixing hole of an optical member and a fixing protrusion of a mold frame.

Referring to FIGS. 10 and 11, a liquid crystal display device 2 may be different from the liquid crystal display device 1 shown in FIG. 2. For example, the fixing protrusion 430_1 of the mold frame 400_1 may be formed on the side wall 420_1, instead of on the upper surface 410_1 of the mold frame 400_1. A region where the fixing portion FT_2 of the second optical member 300_1 is formed may be bent to engage with the fixing protrusion 430_1 of the mold frame 400_1. For example, the second optical member 300_1 may have a first portion that extends in the first direction (e.g., a direction parallel to a plane of the upper surface 410_1) and a second portion that extends in a second direction (e.g., a direction parallel to a height of the sidewall 420_1) substantially orthogonal to the first direction further including segments both above and below the fixing protrusion 430_1. This embodiment may have the similar characteristics to the exemplary embodiment of the present invention described with reference to FIG. 2.

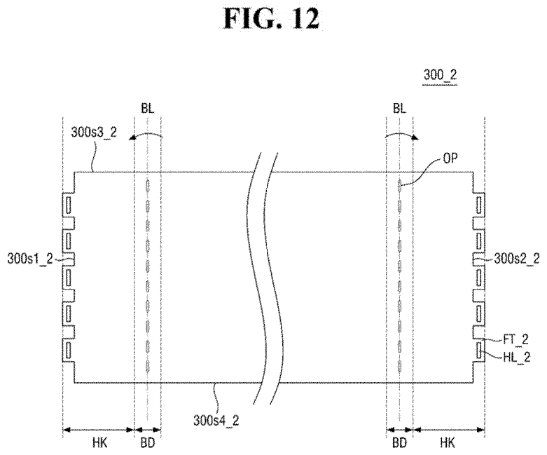

More specifically, the second optical member 300_1 illustrated in FIG. 10 may have a larger area than the second optical member 300_1 shown in FIG. 2 in order to engage with the fixing protrusion 430_1 of the mold frame 400_1. In other words, when the fixing protrusion 430_1 is formed on the side surface 420_1 of the mold frame 400_1, the second optical member 300_1 may further include a bending region BD (shown, for example, in FIGS. 12-14) and an engaging area HK, compared to when the fixing protrusion 430_1 is formed on the upper surface 410_1 of the mold frame 400_1. At least a part of the bending region BD and engaging region HK of the second optical member 300_1 may contact a part of the upper surface 410_1 and side wall 420_1 of the mold frame 400_1, and thus the second optical member 300_1 may be strongly coupled to the mold frame 400. A height from a side surface of the mold frame 400_1 to an end of the fixing protrusion 430_1 may be substantially equal to a thickness of the second optical member 300_1.

At least a part of the upper surface 410_1 and the side wall 420_1 of the mold frame 400_1 and the bending region BD of the second optical member 300_1 and the engaging region HK may be in contact with each other and can be more firmly coupled.

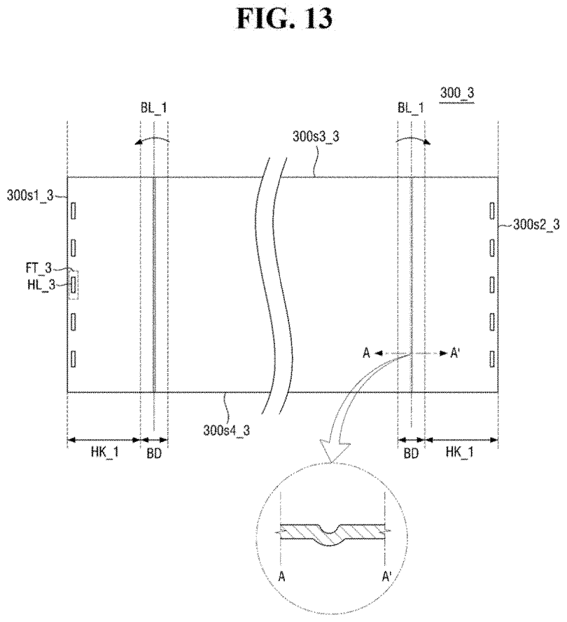

A detailed description of the bending region BD and engaging region HK of the second optical member 300 will be made with reference to FIGS. 12 and 13.

FIGS. 12 and 13 are plan views illustrating a second optical member according to another exemplary embodiment of the present invention.

At least one of the engaging regions of the second optical member 300_1 may be provided with fixing portions FT_2. The second optical member 300_1 may be laminated onto the upper surface 410_1 of the mold frame 400_1 and the fixing protrusions 430_1 formed on the side wall 420_1 and the upper surface 410_1 of the mold frame 400_1 are inserted into the fixing holes HL_2 formed in the fixing portion FT_2 of the second optical member 300_1. That is, the fixing protrusions 430_1 of the mold frame 400_1 penetrate through the fixing holes HL_2 of the second optical member 300_1, and thus the mold frame 400_1 and the second optical member 300_1 are coupled to each other.

Referring to FIG. 12, the fixing portion FT_2 according to an exemplary embodiment of the present invention may be formed to protrude from at least one of side surfaces 300s1_2, 300s2_2, 300s3_2, and 300s4_2 of the second optical member 300_2. The second optical member 300_2 may be a rectangular plate having two long sides 300s3_2 and 300s4_2 and two short sides 300s1_2 and 300s2_2. The second optical member 300_2 may include fixing portions FT_2 disposed at sides thereof. For example, five fixing portions FT_2 may be disposed protruding from each of the left and right short sides 300s1_2 and 300s2_2. Each of the fixing holes HL_2 formed in the plurality of fixing portions FT_2 may have, for example, a rectangular shape. The second optical member 300_2 may include at least one bending line BL extending in a first direction parallel to the short sides 300s1_2 and 300s2_2 and in contact with the upper surface 410_1 and side wall 420_1 of the mold frame 400_1 in a thickness direction of the second optical member 300_2. For example, the bending line BL may refer to a line disposed in the bendable bending region BD experiencing a greatest degree of compression force.

The second optical member 300_2 according to an exemplary embodiment of the present invention may include a plurality of openings OP disposed along the bending line BL in a first direction (e.g., along an axis parallel to a length of short sides 300s2_2 and 300s1_2). The plurality of openings OP may be formed as oval shaped holes with a length extending along the bending line BL. The oval shape may facilitate the bending of the second optical member 300_2 along the bending line BL. However, the shape of the openings OP is not limited thereto. For example, the openings may be formed such that openings OP having two or more sizes are alternately arranged.

Referring to the exemplary embodiment of the present invention illustrated in FIG. 13, the second optical member 300_3 may include fixing portions FT_3 formed inside the second optical member 300_3. The second optical member 300_3 may be a rectangular plate having two long sides 300s3_3 and 300s4_3 and two short sides 300s1_3 and 300s2_3. The second optical member 300_3 may include fixing portions FT_3 spaced apart from the edge of each of the left and right short sides 300s1_3 and 300s2_3 toward the inside of the second optical member 300_3 by a predetermined distance. Each of the fixing holes HL_3 formed in the plurality of fixing portions FT_3 may have a rectangular shape. The second optical member 300_3 may include a bending line BL_1 disposed in an engaging region HK_1 along a line in contact with the upper surface 410_1 and side wall 420_1 of the mold frame 400_1.

The second optical member 300_3 may include a push mark line along the bending line BL_1. The push mark line may refer to a broken line formed by applying pressure to the second optical member 300_3 along the bending line BL_1. With reference to the enlarged cross section taken along line A-A′, a concave portion may be formed on the pressure-applied surface of the second optical member 300_3 and a convex portion may be formed on the other surface thereof, so that the bending of the second optical member 300_3 may be facilitated.

Although it is shown in FIGS. 12 and 13 that five fixing portions FT_2 and FT_3 are formed on each of the left and right short sides of the second optical members 300_2 and 300_3, the number of the fixing portions FT_2 and FT_3 of the second optical members 300_2 and 300_3 and the shapes of the fixing holes HL_2 and HL_3 formed in the fixing portions FT_2 and FT_3 are not limited thereto. For example, the number of the fixing portions FT_2 and FT_3 may be increased or decreased in proportion to the area of the display device (e.g., a length of respective short sides), and the fixing holes HL_2 and HL_3 formed in the fixing portions FT_2 and FT_3 may be formed in various shapes such as a circle, an ellipse, and a polygon, if the shape of each of the fixing hole HL_2 and HL_3 matches the shape of the fixing protrusion 430_1 of the mold frame 400_1.

When the fixing portions FT_2 and FT_3 are disposed on respective upper and lower long sides 300s3_2, 300s4_2, and 300s3_3, 300s4_3 and respective left and right short sides 300s1_2, 300s2_2, and 300s1_3, 300s2_3 of the second optical members 300_2 and 300_3, in order to facilitate the bending of the first optical members 300_2 and 300_3, a predetermined region may be removed from four vertexes of the second optical members 300_2 and 300_3, in order to facilitate the bending of the first optical members 300_2 and 300_3. For example, when each of the second optical members 300_2 and 300_3 has a rectangular shape, a rectangular region BD where the width of the first optical member folded in the long sides 300s3_2, 300s4_2, 300s3_3, and 300s4_3 is set to a first side and the width of the first optical member folded in the short sides is set to a second side may be removed from the vertexes of the first optical members 300_2 and 300_3.

FIG. 12 illustrates a configuration where a plurality of openings OP are formed along the bending line BL of the second optical member 300_2 including the protruding fixing portion FT_2, and FIG. 13 illustrates a configuration where push mark lines are formed along the bending line BL_1 of the second optical member 300_3 in which the fixing portion FT_3 is formed. However, the plurality of openings OP and the push mark lines may be applied along the bending lines BL and BL _1 regardless of the positions of the fixing portions FT_2 and FT_3.

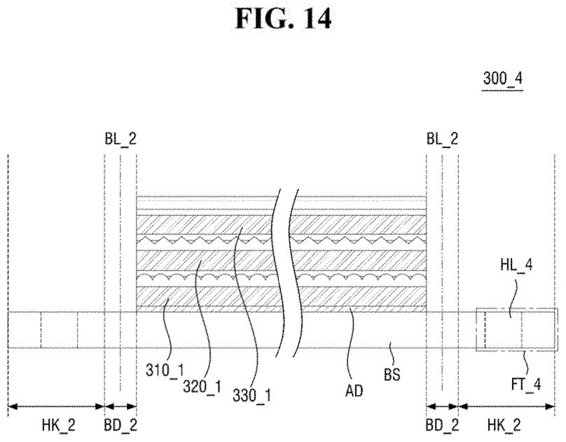

FIG. 14 is a cross-sectional view of a second optical member 300_4 according to an exemplary embodiment of the present invention.

Referring to FIG. 14, a second optical member 300_4 is different from the first optical members 300_2 and 300_3 shown in FIGS. 12 and 13 in that the second optical member 300_4 may further include a base layer BS, and the bending area BD_2 and the engaging area HK_2 may be formed only in the base layer BS. The present embodiment may also have substantially similar characteristics to the embodiment described with reference to FIGS. 12 and 13.

More specifically, in the second optical member 300_4, the aforementioned first film 310_1, second film 320_1, and third film 330_1 may be sequentially laminated using an adhesive disposed between successive films. An adhesive resin layer AD may have an upper surface disposed on the lower surface of the third film 330_1 and a lower surface disposed on an upper surface of the base layer BS.

The base layer BS may be made of a transparent material capable of transmitting light, for example, a polycarbonate-based material, a polysulfone-based material, a polyacrylate-based material, a polystyrene-based material, a polyvinyl chloride-based material, a polyvinyl alcohol-based material, a polynorbornene-based material, and/or a polyester-based material. For example, the base layer BS may be made of polyethylene terephthalate and/or polyethylene naphthalate.

The base layer BS may be provided in the form of a rectangular plate. The base layer BS may overlap the first to third films 310_1, 320_1 and 330_1 in a region excluding the bending region BD_2 and the engaging region HK_2. For example, the base substrate BS may have a portion overlapping the first to third films 310_1, 320_1 and 330_1, and another portion extending across both the bending region BD_2 and engaging region HK_2. Unlike the case of providing a plurality of openings OP and push mark lines to bend the first optical members 300_2 and 300_3 including the first to third films 310, 320 and 330, the second optical member 300_4 shown in FIG. 13 has a structure of bending only the base layer BS, the bending region is relatively thin, and thus the bending of the second optical member 300_4 may be facilitated. Since the bending region BD_2 and engaging region HK_2 of the second optical member 300_4 are regions in which it is not necessary to control the characteristics of the light passing through the first optical member 500, only the base layer BS may be provided, and the first to third films 310_1, 320_1 and 330_1 may be omitted, thereby reducing cost of manufacture.

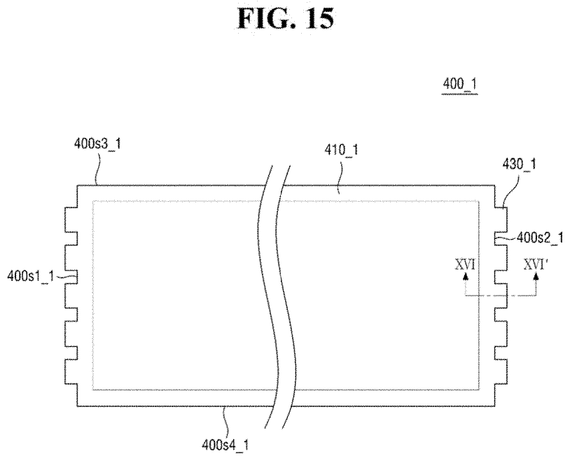

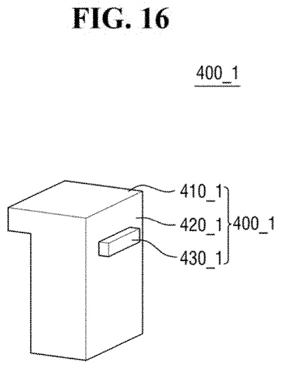

FIG. 15 is a plan view illustrating the mold frame 400_1 of FIG. 10, and FIG. 16 is a perspective view illustrating a cross-section taken along the line XVI to XVI′ of FIG. 15.

A mold frame 400_1 may be disposed between the lower cover 800_1 and the upper cover 100_1 to support and fix the first optical member 500 and the second optical member 300_1. Details thereof will be described with reference to FIGS. 15 and 16.

Referring to FIG. 15, the mold frame 400_1 may have a rectangular shape including two long sides 400s3_1 and 400s4_1 and two short sides 400s1_1 and 400s2_1 when viewed in a plan view. The upper surface 410_1 of the mold frame 400_1 may include a rim disposed adjacent to the edge of the first optical member 500, and a region other than the rim may be an open space within which various components are disposed. The opened region may be a region overlapping the display area of the aforementioned display panel 200. The rim of the mold frame 400_1 may include five fixing protrusions 430_1 at each of the left and right side walls 420_1. Each of the plurality of fixing protrusions 430_I may have a rectangular shape corresponding to the shape of each of the fixing holes HL_1, HL 2, and HL 3 of the first optical members 300_1, 300_2, and 300_3 when viewed in a plan view.

Referring to FIG. 16, the mold frame 400_1 may include a side wall 420_1 engaged with the side wall 820 of the lower cover 800_1, an upper surface 410_1 bent and extended from the side wall 420_1, and a fixing protrusion 430_1 protruding from a sidewall 420_1 configured to fix the second optical member 300. The fixing protrusion 430_1 may have a rectangular parallelepiped shape whose plane shape is rectangular. The fixing protrusion 430_1 may penetrate through the fixing hole HL formed in the fixing portion FT of the second optical member 300_1 and may be engaged with the second optical member 300 to prevent excessive leftward and rightward movement of the first optical member 500 and the second optical member 300_1.

When the fixing portions FT_1, FT_2, and FT_3 of the second optical members 300_1, 300_2, and 300_3 are engaged with the fixing protrusion 430_1 of the mold frame 400_1, it is possible to prevent a problem of misalignment that may occur in assembling a backlight unit and to prevent problems such as light leakage and dark area occurrence. Further, it is possible to prevent damage to the first optical member 500 during testing or transportation and therefore to increase the reliability of the liquid crystal display device.

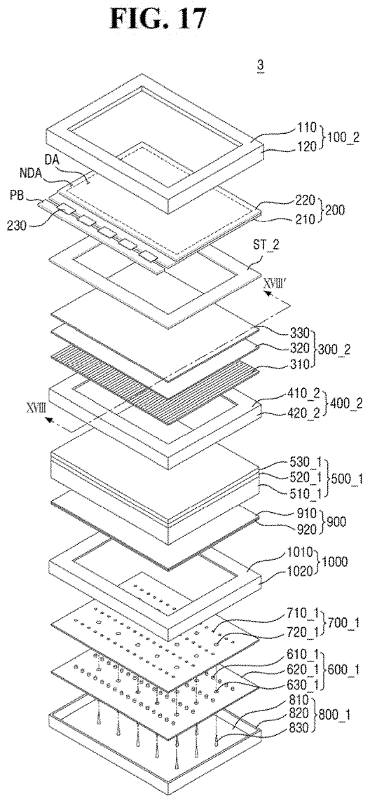

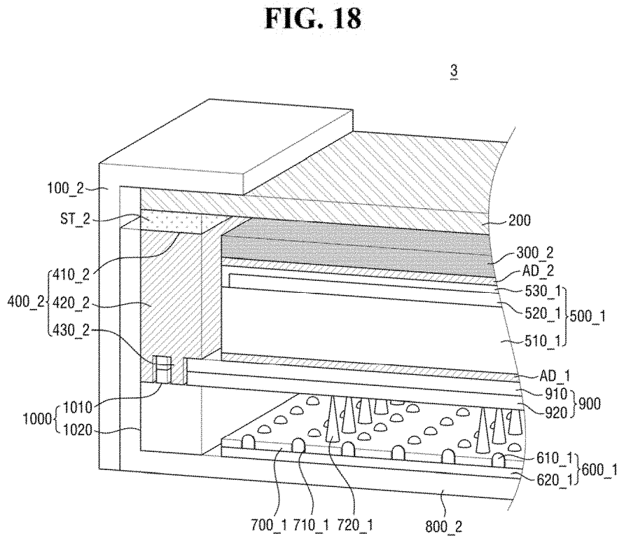

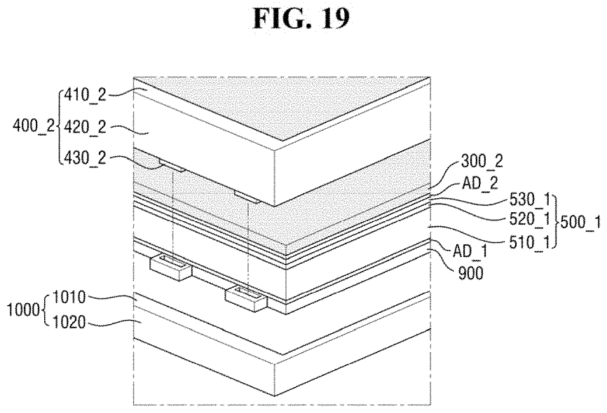

FIG. 17 is an exploded perspective view illustrating a display device according to an exemplary embodiment of the present invention, FIG. 18 is a perspective view illustrating a cross-section taken along the line XVIII-XVIII′ of FIG. 17, and FIG. 19 is a perspective view illustrating engagement between a fixing hole of an optical member and a fixing protrusion of a mold frame.

Referring to FIGS. 17 to 19, a liquid crystal display device 3 according to the an exemplary embodiment of the present invention may have a direct type backlight unit including a light source module for vertically emitting light toward a liquid crystal panel, a reflective sheet perforated to correspond with the upper surface LED light source included in the light source module, a first optical member including a wavelength conversion layer, a light adjustment member filter, and a plurality of mold frames. This direct type backlight unit is different from the edge type backlight unit shown in FIGS. 1 to 3. Hereinafter, components different from those of FIGS. 1 to 3 will be mainly described.

The light source module 600_1 may include a printed circuit board 620_1 on which a circuit pattern is disposed, and a plurality of light sources 610_1 and a plurality of first light adjustment member filter support member insertion holes 630_1, which are disposed on the printed circuit board 620_1 and spaced apart from each other. The first light adjustment member filter support member insertion holes 630_1, which are through holes, are arranged overlapping the light adjustment member filter support member 830 mounted on the lower cover 800_1. The printed circuit board 620_1 may have a rectangular shape, and may include a reflective surface. For example, the surface of the printed circuit board 620_1 may be treated with a material having high light reflectivity.

The plurality of light sources 610_1 may include, for example, light emitting diodes (LEDs). The plurality of light sources 610_1 may provide light for the liquid crystal display device 3 to display an image. The light emitted from the plurality of light sources 610_1 may be guided toward the display panel 200 via the first optical member 500_1. For uniformity of luminance the light source module 600_1 and the plurality of light sources 610_1 may be spaced apart from each other at regular intervals. For example, the plurality of light sources 610_1 may be arranged in a matrix array at predetermined distances in rows and columns (e.g., the horizontal and vertical directions). Consecutive light sources 610_1 may be arranged in parallel to each other in a first direction (e.g., the vertical direction), and may be arranged in a zigzag formation in the second direction (e.g., the horizontal direction). For example, consecutive light sources 610_1 disposed in horizontally extending rows may be parallel to one another and consecutive light sources disposed in adjacent columns may have a staggered arrangement (e.g., a zigzag formation) with respect to one another. However, the present invention is not limited thereto; the light sources 610_1 may be arranged on the printed circuit board 620_1 in various arrangements.

The reflective sheet 700_1 may be disposed on the lower cover 800_1 and the printed circuit board 620_1. The reflective sheet 700_1 is made of a reflective material, and may reflect at least some of the tight emitted from the light source module 600_1 in the direction of the first optical member 500_1 toward the lower cover 800_1.

The reflective sheet 700_1 may be disposed on the printed circuit board 620_1. The reflection sheet 700_1 may include a plurality of light source module insertion holes 710_1 and a plurality of second light adjustment member filter support member insertion holes 720_1. The light source modules 610_1 mounted on the printed circuit board 620_1 may be exposed on the upper surface of the reflective sheet 700_1 through the plurality of light source module insertion holes 710_1. The light adjustment member filter support member 830 mounted on the lower cover 800_1 may be connected to the reflective sheet 700_1 through the plurality of second light adjustment member filter support member insertion holes 720_1. For example, the light adjustment member filter support members 830 may at least partially penetrate through both the first light adjustment member filter support member insertion holes 630_1 and the second light adjustment member filter support member insertion holes 720_1.

The lower cover 800_1 may have a space capable of accommodating the first optical member 500_1, the second optical member 300_2, the light source module 600_1, the reflective sheet 700_1, and the mold frame 400_2. Specifically, the lower cover 800_1 may include a bottom plate 810, a side wall 820 protruding upward and extending along the periphery of the bottom plate 810, and light adjustment member filter support members 830 protruding upward from the bottom plate 810.

The light adjustment member filter support members 830 may be disposed on the bottom plate 810 and may extend therefrom in a substantially vertical direction. The light adjustment member filter support members 830 may be disposed between the bottom plate 810 and the light adjustment member filter 900 to support the light adjustment member filter 900. Although the edges of the light control member filter 900 may be supported by the plurality of mold frames 400_2 and 1000, the central portion of the light adjustment member filter 900 may be deformed by a load when the backlight unit and the liquid crystal display device are enlarged. According to an exemplary embodiment of the present invention, the light adjustment member filter support member 830 may penetrate through the reflective sheet 700_1 overlapping the central portion of the light adjustment member filter 900, and may have a protrusion height which is substantially the same as a distance between the bottom plate 810 and the light adjustment member filter 900. Therefore, the light adjustment member filter support members 830 may support the light adjustment member filter 900.

The first optical member 500_1 may be a region disposed on the light emission path of the light emanating from the light source module 600_1, and the light emitted from the light source module 600_1 may be incident on the first optical member 500_1. At least a part of the light incident on the first optical member 500_1 may be converted or shifted by the wavelength conversion layer 520_1 disposed in the first optical member 500_1 to be emitted toward the display panel 200. The optical member 500_1 may be disposed between the light source module 600_1 and the display panel 200 to increase the luminance uniformity of the light emitted from the light source module 600_1 toward the display panel 200.

The first optical member 500_1 may include a glass plate 510_1, a wavelength conversion layer 520_1 disposed on the glass plate 510_1, and a passivation layer 530_1 disposed on the wavelength conversion layer 520_1. The thicknesses of the wavelength conversion layer 520_1 and the passivation layer 530_1 may be exaggerated for the sake of convenience of explanation. However, each of the actual thicknesses of the wavelength conversion layer 520_1 and the passivation layer 530_1 may be much thinner than the thickness of the glass plate 510_I. In other words, the overall shape of the first optical member 500_1 may be similar to that of the glass plate 510_1.

The glass plate 510_1 may provide a medium through which the light emitted from the light source module 600_1 may travel. The glass plate 510_1 may be configured to provide a space for placing the wavelength conversion layer 520_1.

The glass plate 510_1 may have a substantially polygonal columnar shape. The glass plate 510_1 may include upper and lower surfaces 510a and 510b disposed in parallel to each other, and may include a side surface 510s joining the upper surface 510a and the lower surface 51% at an inclination. The width of the upper surface 510a may be smaller than the width of the lower surface 510b. That is, the glass plate 510_1 may have a trapezoidal shape.

The glass plate 510_1 may be an optical plate made of glass. However, the present invention is not limited thereto, and the glass plate 510_1 may be made of an inorganic material, not glass. The glass plate 510_1 may seal the wavelength conversion layer 520_1 disposed between the glass plate 510_1 and the passivation layer 530_1 through the inorganic-inorganic bonding with the passivation layer 530_1 (to be described later).

The wavelength conversion layer 520 may convert the wavelength of at least a part of the incident light. The wavelength conversion layer 520 may include a binder layer and wavelength conversion particles dispersed in the binder layer. The wavelength conversion layer 520 may further include scattering particles dispersed in the binder layer in addition to the wavelength conversion particles.

A passivation layer 530 may be disposed on the wavelength conversion layer 520. The passivation layer 530 serves to prevent the permeation of impurities such as moisture or oxygen. The passivation layer 530 may include an inorganic material. The passivation layer 530 may completely overlap the wavelength conversion layer 520, cover the upper surface of the wavelength conversion layer 520, and extend further outwardly therefrom to cover the side surface of the wavelength conversion layer 520. The passivation layer 530 may be in contact with the upper surface and at least one side surface of the wavelength conversion layer 520. For example, the passivation layer 530 may have a greater surface area than the wavelength conversion layer 520, and the passivation layer 530 may include a bent shape that covers both an upper surface of the wavelength conversion layer 520 and side surfaces of sides shorter than corresponding sides of the passivation layer 530.

The light adjustment filter 900 may be disposed on at least one surface of the first optical member 500_1.

The optical member adhesive layer AD_1 may be interposed between the light adjustment filter 900 and the first optical member 500_1 to attach them to each other. The optical member adhesive layer AD_1 may be a film exerting adhesive properties at both the upper and lower surface, and may be made of, for example, pressure-sensitive adhesive (PSA), optical clear adhesive (OCA), or optical clear resin (OCR). The optical member adhesive layer AD_1 may include acrylic resin and/or silicone resin. The optical member adhesive layer AD_1 may have an elongation rate of 100% to 1,000% and a refractive index of 1.0 to 1.6.

The lower surface of the optical member adhesive layer AD_1 may be disposed on the upper surface of the light adjustment filter 910, and the upper surface of the optical member adhesive layer AD_1 may be disposed on the lower surface of the first optical member 500_1. The planar area of the optical member adhesive layer AD_1 may be equal to the planar area of the display area of the display panel 200. However, the present invention is not limited thereto, and the area of the optical member adhesive layer AD_1 may be larger than the area of the display area. For example, the planar area of the optical member adhesive layer AD_1 may be equal to the planar area of the first optical member 500_1.

When the light adjustment filter 900 is attached to the first optical member 500_1 by the optical member adhesive layer AD_1, the occurrence of scratches due to friction can be prevented, and when the light adjustment filter 900 is attached to the rigid surface of the first optical member 500_1, sheet stick can be prevented thereby increasing the reliability of the liquid crystal display device.

The light adjustment filter 900 may minimize the transmittance of a specific wavelength range. The light control filter 900 may use a dichroic filter or a dichroic mirror. The dichroic filter may absorb a specific wavelength range and minimize transmittance while transmitting other wavelengths of light. The dichroic mirror may reflect a specific wavelength range to minimize transmittance within that range, and may change the phase of a reflected wavelength and reuse the reflected wavelength to reduce light loss. According to an exemplary embodiment of the present invention, the light adjustment filter 910 may prevent a phenomenon yellowish light transmission by transmitting only blue light.

According to an exemplary embodiment of the present invention, the light adjustment filter 900 may include a light adjustment filter layer 910 and a lower film 920 to prevent tearing and scratching. For example, a polyester (PET) film may be used as the lower film 920, and a hard coating may be further applied to at least one side of the polyester film.

The lower film 920 may be a diffuser film for uniformly diffusing the light emitted from the light source module 600_1. In other words, the lower film may serve to improve the luminance uniformity of the light emitted from the light source 610_1. Specifically, the lower film 920 according to an exemplary embodiment of the present invention may prevent bright spots from being visible from the front of the liquid crystal display device 3.

The first mold frame 400_2 and the second mold frame 1000 may be disposed between the lower cover 800_2 and the upper cover 100_2 to support/fix the first optical member 500_1 and the light adjustment filter 900. Spacer tape ST_2 may be disposed between the first mold frame 400_2 and the display panel 200. The spacer tape ST_2 may have a lower surface disposed on the first mold frame 400_2 (e.g., disposed on an upper surface 410_2) and an upper surface disposed on the display panel 200. The first mold frame 400_2 may further include fixing protrusions 430_2 disposed on a lower region thereof. The sidewall 420_2 may extend from a surface of the second mold frame 1000. The fixing protrusions 430_2 may also contact the second mold frame 1000. The lower portions of the sidewall 420_2 and an adjacent fixing protrusion 430_2 may form a double pronged shape that straddles a protruding region of the light adjustment filter 900 and interlocks therewith. For example, the light adjustment filter 900 may feature a protrusion remotely spaced from the remainder of the light adjustment filter 900 that corresponds to a space formed between the sidewall 420_2 and an adjacent fixing protrusion 430_2. However, the present invention is not limited thereto. An adhesive layer AD_2 may be disposed between the second optical member 300_2 and the first optical member 500_1.

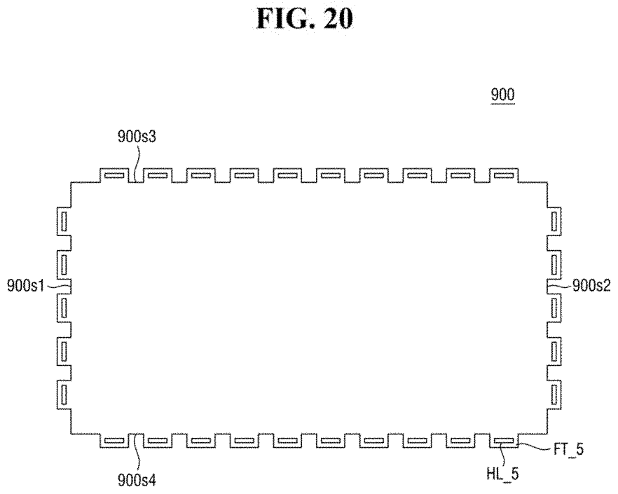

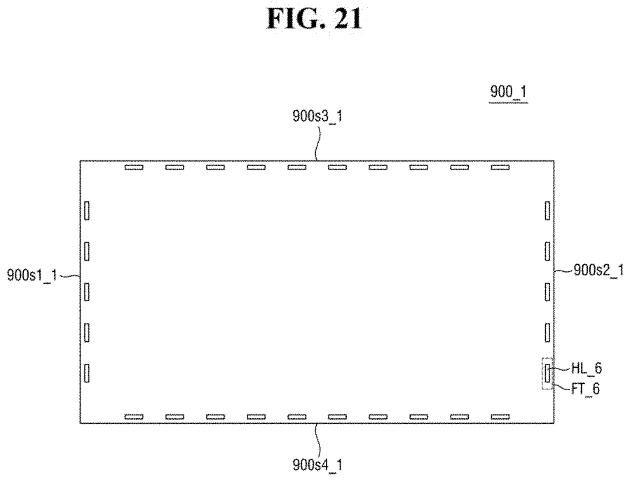

FIGS. 20 and 21 are plan views illustrating a light adjustment filter according to an exemplary embodiment of the present invention.

At least one side of each of the light adjustment filters 900 and 900_1 may be provided with fixing portions FT_5 and FT_6, and the fixing portions FT_5 and FT_6 may be provided with fixing holes HL_5 and HL_6, respectively. The fixing protrusions 430_2 formed on the lower surface of the mold frame 400 may be inserted into the fixing holes HL_5 and HL_6 formed on the fixing portions FT_5 and FT_6 of the light adjustment filters 900 and 900_I. In other words, the fixing protrusions 430_2 of the mold frame 400_2 may penetrate through the fixing holes HL_5 and HL_6 of respective light control filters 900 and 900_1, and may be coupled thereto.

Referring to FIG. 20, the fixing portions FT_5, according to an exemplary embodiment of the present invention, may protrude from the side surfaces 900s1, 900s2, 900s3, and 900s4 of the light adjustment filter 900. The light adjustment filter 900 may be a rectangular plate having two long sides 900s3 and 900s4 and two short sides 900s1 and 900s2. The light adjustment filter 900 may include ten fixing portions FT_5 protruding from each of the upper and lower long sides 900s3 and 900s4 and five fixing portions FT_5 protruding from the left and right short sides 900s1 and 900s2. Each of the fixing holes HL_5 formed in the plurality of fixing portions FT_5 may have a rectangular shape.

Referring to an exemplary embodiment of the present invention illustrated in FIG. 21, the fixing portions FT_6 may be formed inside the light control filter 900_1 rather than protruding therefrom. The light adjustment filter 900_1 may be a rectangular plate including two long sides 900s3_1 and 900s4_1 and two short sides 900s1_1 and 900s2_1. The light adjustment filter 900_1 may include ten fixing portions FT_6 spaced apart from the edge of each of the upper and lower long sides 900s3_1 and 900s4_1 toward the inside of the light adjustment filter 900_1 by a predetermined distance. Five fixing portions FT_6 may be spaced apart from the edge of each of the left and right short sides 900s1_1 and 900s2_1 toward the inside of the light adjustment filter 900_1 by a predetermined distance.

However, the number of the fixing portions FT_5 and FT_6 of the light adjustment filter 900 and the light adjustment filter 900_1 and the shapes of the fixing holes HL_5 and HL_6 formed in the fixing portions FT_5 and FT_6 are not limited thereto. For example, the number of the fixing portions FT_5 and FT_6 may be increased or decreased in proportion to the area of the display device, and each of the fixing holes HL_5 and HL_6 formed in the fixing portions FT_5 and FT_6 may be various shapes such as a circle, an ellipse, and a polygon, if the shapes of the fixing holes HL_5 and HL_6 matches the shapes of the fixing protrusion 430_2 of the mold frame 400_2.

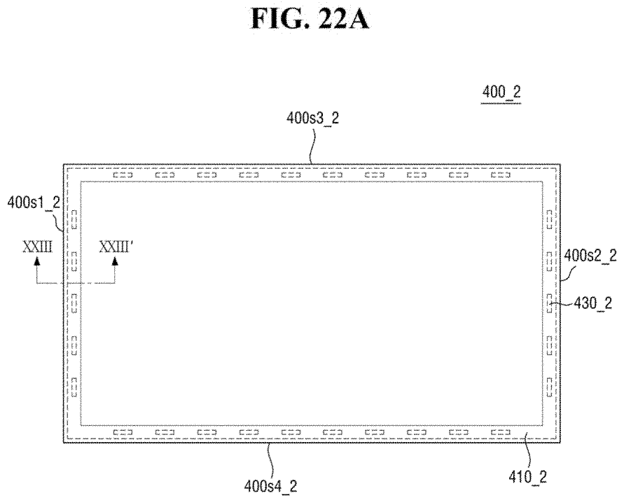

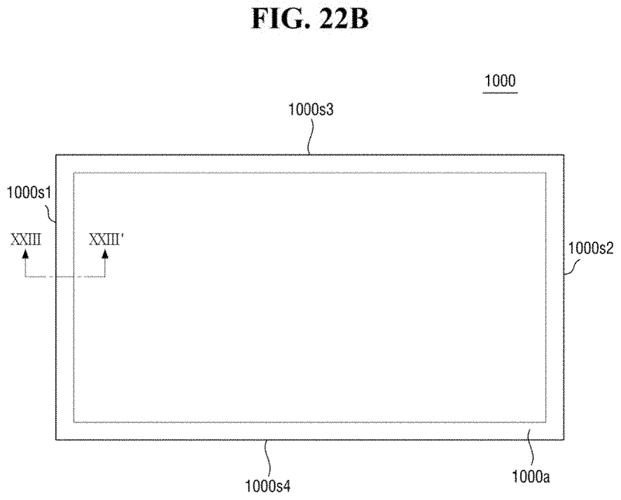

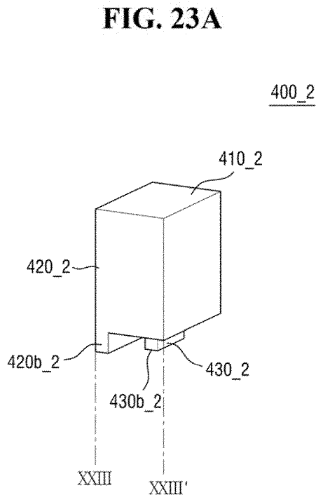

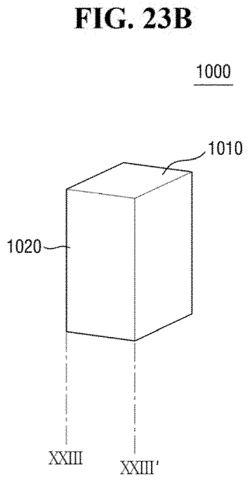

FIGS. 22A and 22B are plan views of a first mold frame and a second mold frame according to an embodiment, and FIGS. 23A and 23B are perspective views showing cross-sections taken along the line XXIII-XXIII′ of FIGS. 22A and 22B.

Referring to FIGS. 22A and 22B, a first mold frame 400_2 may have a rectangular shape including two long sides 400s3_2 and 400s4_2 and two short sides 400s1_2 and 400s2_2 in a plan view. A second mold frame 1000 may have a rectangular shape including two long sides I 000s3 and 1000s4 and two short sides 1000s1 and 1000s2 in a plan view. The body 1000a of the second mold frame 1000 may be abounded by the aforementioned sides, and a central space between parallel solid lines may be an open space. The first mold frame 400_2 and the second mold frame 1000 may be disposed to overlap each other. According to an exemplar embodiment of the present invention, the four sides 400s1_2, 400s2_2, 400s3_2, and 400s4_2 of the first mold frame 400_2 may be aligned with the four sides 1000s1, 1000s2, 1000s3, and 1000s4 of the second mold frame 1000, respectively.

The first mold frame 400_2 and the second mold frame 1000 support/fix the aforementioned light adjustment filter 900. The first mold frame 400_2 may include side walls 420_2 formed along the edges of the rectangular shape, and may have an opening window at the center thereof such that light passing through the first optical member 500_1 and the light adjustment filter 900 can be outwardly transmitted. On the lower surface of the first mold frame 400_2, ten fixing protrusions 430_2 are provided at each of the upper and lower sides 400s3_2 and 400s4_2, and five fixing protrusions 430_2 are provided at each of the left and right sides 400s1_2 and 400s2_2. Each of the plurality of fixing protrusions 430_2 may have a rectangular shape corresponding to the shape of each of the fixing holes HL_5 and HL_6 of the light adjustment filter 900. The open region may be a region overlapping the display area (active area) of the display panel 200.

Referring to FIGS. 23A and 23B depicting a cross section taken along line XXIII-XXIII' of FIG. 22A, the first mold frame 400_2 may include a side wall 420_2 engaged with the side wall 820 of the lower cover 800_2, an upper surface 410_2 extending from the side wall 420_2 may fix the display panel 200, and a fixing protrusion 430_2 protruding from a lower surface opposite to the upper surface 410_2 may fix the light adjustment filter 900. The fixing protrusions 430_2 may have a rectangular parallelepiped shape whose plane shape is rectangular. The fixing protrusion 430_2 may be engaged with the light adjustment filter 900 through each of the fixing holes HL_5 and HL_6 formed in the fixing portions FT _5 and FT_6 of the light adjustment filter 900.

The second mold frame 1000 may include a side wall 1020 engaged with the side wall 820 of the lower cover 800_2 and an upper surface 1010 extended in a depth dimension from the side wall 1020 which may fix the light adjustment filter 900. The lower end 430b_2 of the fixing protrusion 430_2 of the first mold frame 400_2 and the lower end 420b_2 of the side wall 4202 of the first mold frame 400_2 may be disposed on the upper surface 1010 of the second mold frame 1000. The first mold frame 400_1 and the second mold frame 1000 may be engaged with each other by separate engaging means.

When the fixed portions FT_5 and FT_6 of the light adjustment filter 900 are engaged with the fixing protrusion 430_2 of the mold frame 400_2, it is possible to prevent a problem of misalignment that may occur in assembling a backlight unit and to prevent problems such as light leakage and dark area occurrence, and it is also possible to prevent damage to the first optical member 500_1 that may occur during testing or transportation. Thus, reliability of the liquid crystal display device may be improved.

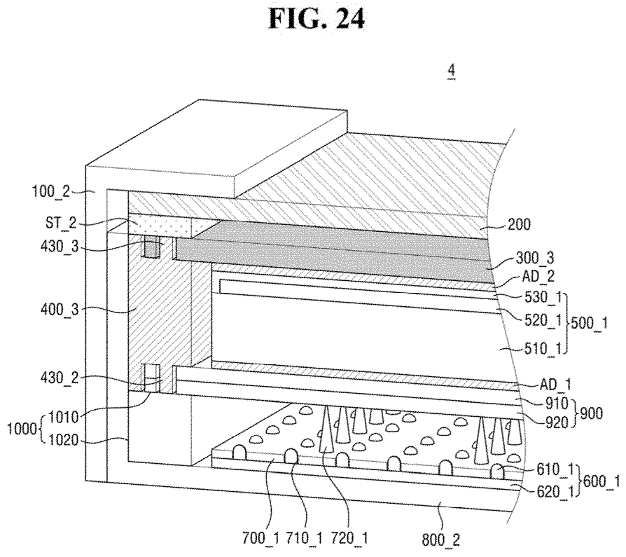

FIG. 24 is a cross-sectional view of a liquid crystal display device according to another exemplary embodiment of the present invention.

Referring to FIG. 24, a liquid crystal display device 4 is different from the liquid crystal display device 3 shown in FIG. 18 in that the liquid crystal display device 4 further includes a second fixing protrusion 430_3 on the upper surface of a first mold frame 400_3, and further includes a second optical member 300_3 having fixing portions.

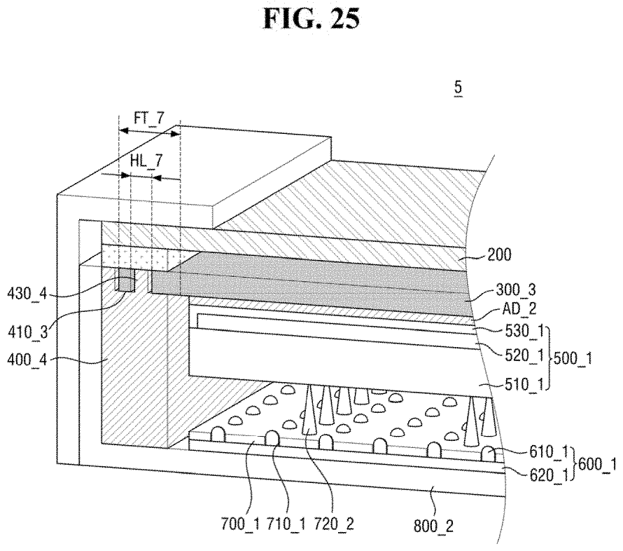

More specifically, the second optical member 300_3 may be attached to the first optical member 500_1 through the adhesive layer AD_2. The second fixing protrusion 430_3 disposed on the upper surface of the first mold frame 400_3 may penetrate through the fixing hole HL_7 (shown in FIG. 25) formed in the fixing portion FT_7 of the second optical member 300_3 to engage the second optical member 300_3 with the first optical member 500_1. Thus, the characteristics of the light emitted from the light source module 600_1 can be adjusted to increase light transmittance and luminance, and the movement of the first optical member 500_1, the light adjustment pattern 900 and the second optical member 300_3 can be further prevented, so that the reliability of the display device can be increased.

FIG. 25 is a cross-sectional view of a liquid crystal display device according to another exemplary embodiment of the present invention.

Referring to FIG. 25, a liquid crystal display device 5 is different from the liquid crystal display device 4 shown in FIG. 24 in that the liquid crystal display device 5 does not possess the light adjustment pattern 900, and that the first mold frame and the second mold frame are integrally formed. Thus a single fixing protrusion 430_4 may be provided on an upper surface of the integrally formed mold frame 400_4.

The second optical member 300_3 may be attached to the first optical member 500_1 through the adhesive layer AD_2. The second fixing protrusion 430_4 disposed on the upper surface 410_3 of the first mold frame 400_4 may penetrate through the fixing hole HL_7 formed in the fixing portion FT_7 of the second optical member 300_3 and may engage with the second optical member 300_3 and the first optical member 500_1 attached thereto. Thus, the movement of the first optical member 500_1 and the second optical member 300_3 can be prevented, so that the reliability of the display device can be increased.

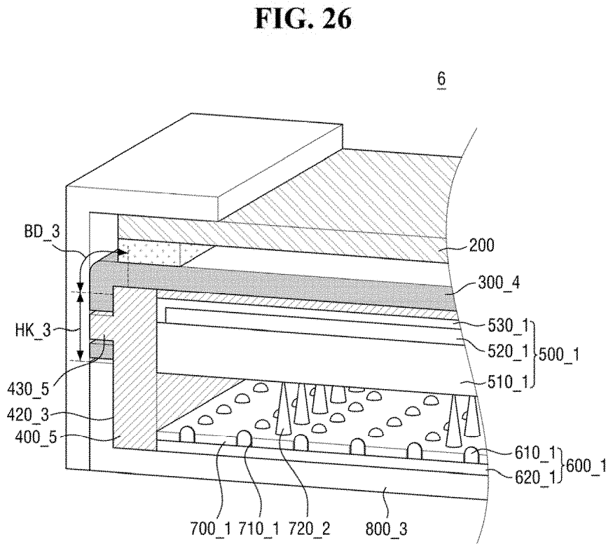

FIG. 26 is a cross-sectional view illustrating a liquid crystal display device 6 according to an exemplary embodiment of the present invention.

Referring to FIG. 26, a liquid crystal display device 6 is different from the liquid crystal display device 5 shown in FIG. 25 in that the liquid crystal display device 6 may include a fixing protrusion 430_5 extending laterally from the side wall 420_3 of the first mold frame 400_5, and may further include a second optical member 300_4 including a bending region BD_3 and an engaging region HK_3.

More specifically, the second optical member 300_4 shown in FIG. 26 may have a larger area than the second optical member 300_3 shown in FIG. 25 so as to engage with the fixing protrusion 430_5 of the first mold frame 400_5. That is, when the fixing protrusion 430_5 is formed on the side wall 420_3 of the first mold frame 400_4, the second optical member 300_4 may further include a bending region BD_3 and an engaging region HK_3, compared to when the fixing protrusion 430_4 is formed on the upper surface 410_3 of the first mold frame 400_4. In this case, at least a part of the bending region BD_3 and engaging region HK_3 of the second optical member 300_4 is attached to at least a part of the upper surface 410_4 and side wall 420_3 of the first mold frame 400_5. Thus, the second optical member 300_4 may be strongly coupled to the first mold frame 400_5.

While the present invention has been particularly shown and described in reference to exemplary embodiments thereof, it will be understood by those of ordinary skill in the art that various changes in form and detail may be made herein without departing from the scope of the present invention as defined by the following claims.

What is claimed is:

1. A backlight unit, comprising:
a first optical member, wherein the first optical member includes a protrusion extending from a surface of the first optical member; and
a mold frame partially surrounding the surface of the first optical member,
wherein the protrusion of the first optical member includes a fixing hole, and
the mold frame includes at least one fixing protrusion configured to be inserted into the fixing hole of the protrusion.

2. The backlight unit of claim 1,
further comprising a second optical member disposed on the first optical member, wherein the second optical member includes a glass plate.

3. The backlight unit of claim 2,
wherein the second optical member further includes a wavelength conversion layer disposed on the glass plate and a passivation layer covering the wavelength conversion layer.

4. The backlight unit of claim 2,
wherein an optical member adhesive layer is disposed between the first optical member and the second optical member.

5. The backlight unit of claim 1,
further comprising a second optical member disposed on the first optical member, wherein the second optical member includes a light guide plate.

6. The backlight unit of claim 1,
wherein the first optical member further includes a first optical film, a second optical film disposed on the first optical film, and a film adhesive layer disposed between the first optical film and the second optical film to attach the first optical film to the second optical film.

7. The backlight unit of claim 6,
wherein the fixing hole penetrates through the first optical film and the second optical film.

8. The backlight unit of claim 1,
wherein the fixing protrusion is disposed on an upper surface of the mold frame, and a height from the upper surface of the mold frame to an upper end of the fixing protrusion is equal to a thickness of the second optical member.

9. The backlight unit of claim 1,
wherein the fixing protrusion is disposed on at least one side surface of the mold frame, and a height from the side surface of the mold frame to an end of the fixing protrusion is equal to a thickness of the second optical member.

10. The backlight unit of claim 9,
wherein the first optical member further includes a bending region and an engaging region.

11. The backlight unit of claim 10,
wherein the first optical member includes a plurality of openings disposed along a bending line in the bending region.

12. The backlight unit of claim 10,
wherein the first optical member includes a push mark line overlapping a bending line in the bending region, and
a first surface of the first optical member forms a concave portion along the push mark line, and a second surface of the first optical member forms a convex portion along the push mark line.

13. The backlight unit of claim 10,
wherein the first optical member further includes an optical function layer disposed on a base layer, and
the bending region and the engaging region are formed only on the base layer.

14. A backlight unit, comprising:
an optical member including a first optical member;
a light adjustment member filter disposed on the first optical member and including a protrusion region;
a first mold frame surrounding the side surface of the first optical member and overlapping the protrusion region of the light adjustment member filter; and
a second mold frame overlapping the first mold frame and supporting the first mold frame and the light adjustment member filter,
wherein the light adjustment member filter includes at least one fixing hole formed in the protrusion region, and
the first mold frame includes at least one fixing protrusion configured to be inserted into the fixing hole of the light adjustment member filter.

15. The backlight unit of claim 14,
wherein the first optical member includes a glass plate.

16. The backlight unit of claim 15,
wherein the first optical member further includes a wavelength conversion layer disposed on the glass plate and a passivation layer covering the wavelength conversion layer.

17. The backlight unit of claim 15,
wherein the optical member further includes an optical member adhesive layer disposed between the first optical member and the light adjustment member filter.

18. A display device, comprising:
a display panel; and
a backlight unit disposed on a surface of the display panel and configured to provide light to the display panel,
wherein the backlight unit includes:
a light source;
an optical member including a first optical member including a wavelength conversion layer, and a second optical member disposed on the first optical member and including a protrusion region protruding outward beyond a side surface of the first optical member; and
a first mold frame surrounding the side surface of the first optical member and overlapping the protrusion region of the second optical member,
wherein the second optical member includes at least one fixing hole formed in the protrusion region, and
the first mold frame includes at least one fixing protrusion configured to be inserted into the fixing hole of the second optical member.

19. The display device of claim 18, further comprising:
a spacer adhesive member disposed between the display panel and the second optical member and between the display panel and the mold frame.

20. The display device of claim 19,
wherein the spacer adhesive member covers the fixing hole.

21. The display device of claim 18, wherein the first mold frame further includes a second fixing protrusion configured to be inserted into a fixing hole disposed in a light adjustment member, wherein the light adjustment member is disposed below the first optical member and second optical member.

22. The display device of claim 21, further comprising a second mold frame overlapping a lower surface of the first mold frame and a portion of the light adjustment member.
